(19) United States
(12) Patent Application Publication
(10) Pub. No.: US 2013/0106639 A1
(43) Pub. Date: May 2, 2013

(54) ELECTROMAGNETIC ANECHOIC CHAMBER

(71) Applicant: XIAO-LIAN HE, Shenzhen City (CN)

(72) Inventor: XIAO-LIAN HE, Shenzhen City (CN)

(73) Assignees: HON HAI PRECISION INDUSTRY CO., LTD., Tucheng (TW); HONG FU JIN PRECISION INDUSTRY (ShenZhen) CO., LTD, Shenzhen City (CN)

(21) Appl. No.: 13/325,012

(22) Filed: Dec. 13, 2011

(30) Foreign Application Priority Data
Oct. 31, 2011 (CN) 201110337344.8

(51) Int. Cl. H01Q 17/00

(52) U.S. Cl. 342/1

(57) ABSTRACT

An electromagnetic anechoic chamber includes a support board, a cover, and a number of adjustable boards. The support board defines an opening. The cover covers the support board to form a test chamber between the cover and the support board, electromagnetic wave absorptive material spread on the support board and an inner surface of the cover. Each of the adjustable boards includes an electromagnetic wave absorption layer disposed on one surface thereof and a electromagnetic wave reflection layer disposed on an opposite surface thereof, and is rotatably mounted on the support board and received in the opening to selectively allow the electromagnetic wave absorption layer or the electromagnetic wave reflection layer being inward the test chamber.

### BACKGROUND

1. Technical Field

The present disclosure relates to quality testing of information technology equipments (ITE), and particularly to an electromagnetic anechoic chamber for quality testing of ITE.

2. Description of Related Art

Electromagnetic anechoic chambers are often used in quality testing of information technology equipments (ITE), such as personal computers (PC) and liquid crystal displays (LCD). Electromagnetic anechoic chambers include fully anechoic chambers and semi anechoic chambers. In many quality test processes, the ITE may need to be respectively tested in fully anechoic chambers and semi anechoic chambers. Transferring the ITE between fully anechoic chambers and semi anechoic chambers requires additional work.

Therefore, there is room for improvement within the art.

### BRIEF DESCRIPTION OF THE DRAWINGS

Many aspects of the present disclosure can be better understood with reference to the following drawing. The components in the various drawings are not necessarily drawn to scale, the emphasis instead being placed upon clearly illustrating the principles of the present disclosure. Moreover, in the drawings, like reference numerals designate corresponding parts throughout the figure.

FIG. 1 is a cutaway view of an electromagnetic anechoic chamber, according to an exemplary embodiment.

FIG. 2 is a schematic view of switching the electromagnetic anechoic chamber shown in FIG. 1 between different test modes.

FIG. 3 is an enlarged view of the circular part III shown in FIG. 1.

### DETAILED DESCRIPTION

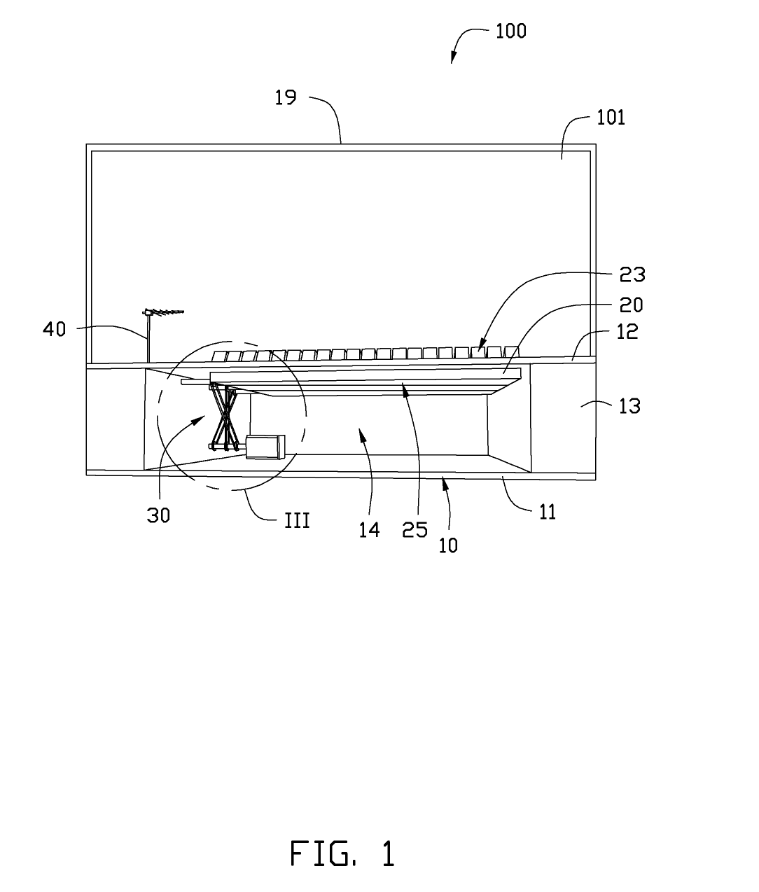

FIG. 1 is a schematic view of an electromagnetic anechoic chamber 100, according to an exemplary embodiment. The electromagnetic anechoic chamber 100 can be used to measure strength of unwanted electromagnetic radiation signals generated by information technology equipments (ITE), such as personal computers (PC) and liquid crystal displays (LCD), for example.

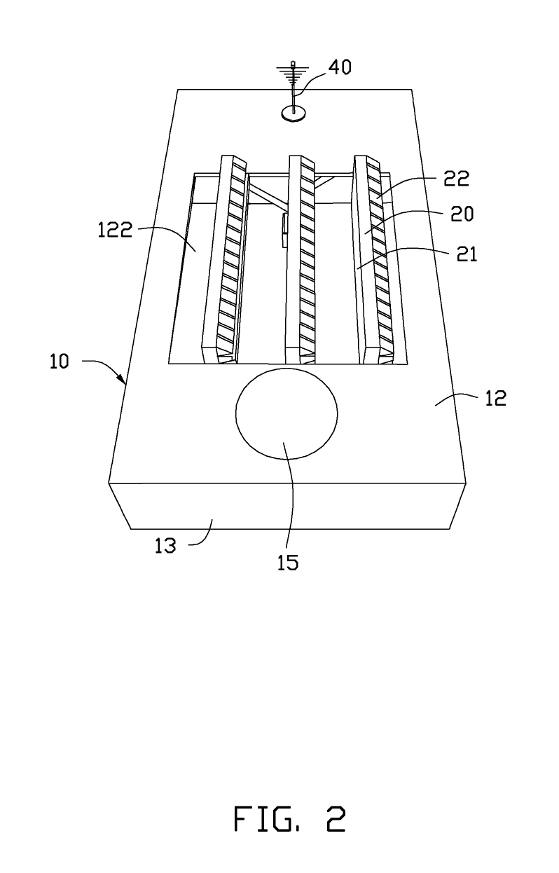

The electromagnetic anechoic chamber 100 includes a housing 10, a cover 19, a number of adjustable boards 20, a drive unit 30, and a test antenna 40. The housing 10 is substantially a cuboid-shaped box and includes a base board 11, a support board 12, and four side boards 13. Also referring to FIG. 2, the base board 11 and the support board 12 are respectively connected to opposite sides of each of the side boards 13 and positioned to be substantially parallel to each other. Thus, the base board 11, the support board 12, and the side boards 13 cooperatively form a containing chamber 14. The cover 19 is positioned above the support board 12 and covers the support board 12, and a test chamber 101 is thereby formed between the cover 19 and the support board 12. Electromagnetic wave absorptive material is spread on an inner surface of the cover 19 and a top surface of the support board 12.

The support board 12 defines an opening 122 in a center thereof, and the adjustable boards 20 are all rotatably mounted on the top board 12 and received in the opening 122. Each of the adjustable boards 21 is substantially a rectangular planar board and includes two parallel planar surfaces. A reflection layer 21 made of electromagnetic wave reflective material is disposed on one of the two planar surfaces, and an absorption layer 22 made of electromagnetic wave absorptive material is disposed on the other of the two planar surfaces. In this embodiment, all of the adjustable boards 20 are positioned to be substantially parallel to each other. A length of each of the adjustable boards 20 equals a length of the opening 122, and a sum of widths of all of the adjustable boards 20 equals a width of the opening 122.

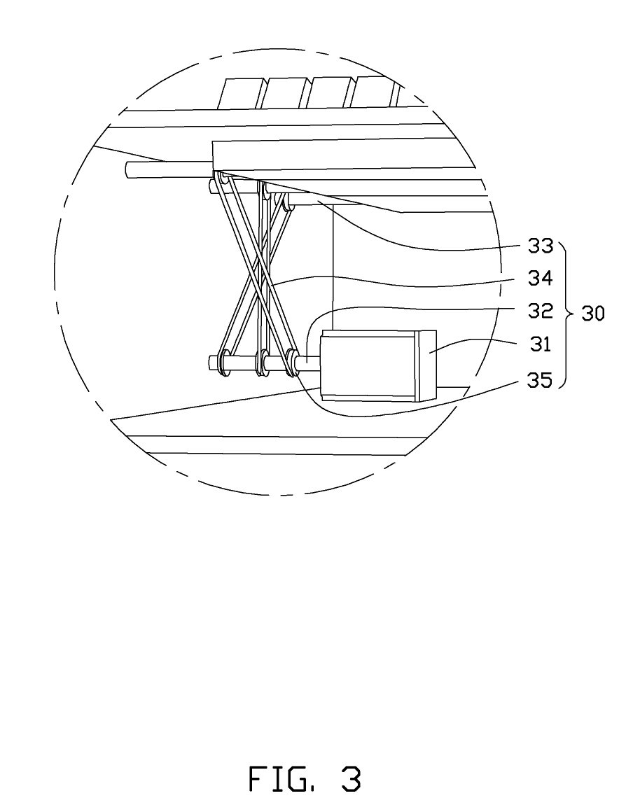

The drive unit 30 is received in the containing chamber 14. Also referring to FIG. 3, the drive unit 30 includes a motor 31, a drive shaft 32, a number of driven shafts 33 corresponding to the adjustable boards 20, and a number of transmission belts 34 corresponding to the driven shafts 33. The drive shaft 32 is mounted on the motor 31 and can be driven to rotate by the motor 31, and each of the driven shafts 33 are longitudinally fixed on an end of a corresponding one of the adjustable boards 20. A plurality of pulleys 35 corresponding to the transmission belts 35 are coaxially mounted on the drive shaft 32. Each of the transmission belts 34 has one end coiled on a corresponding one of the pulleys 35 and another end coiled on a corresponding one of the driven shafts 33. When the motor 31 drives the drive shaft 32 to rotate, the rotation of the drive shaft 32 can drive the driven shafts 33 to rotate via the pulleys 35 and the transmission belts 34, and further cause the adjustable boards 20 to rotate to predetermined positions. Additionally, gears can also replace the transmission belts 34.

The test antenna 40 is a typical test antenna for electromagnetic radiation strength testing. The test antenna 40 is fixed on the support board 12 and electrically connected to typical electromagnetic radiation strength measuring devices (not shown) outside the electromagnetic anechoic chamber 100. The support board 12 has a test position area 15, which is in a predetermined distance away from the test antenna 40. Electromagnetic radiation signals generated by the tested ITE positioned on the test position area 15 can be received by the test antenna 40 and transmitted to the electromagnetic radiation strength measuring devices.

In use, the electromagnetic anechoic chamber 100 can be switched between a fully anechoic test mode and semi anechoic test mode, that is, can respectively serve as a fully anechoic chamber and a semi anechoic chamber. As shown in FIG. 1 and FIG. 2, when the electromagnetic anechoic chamber 100 needs to serve as a fully anechoic chamber, the motor 31 is turned on and drives the adjustable boards 20 to rotate through the drive shaft 32, the transmission belts 34, and the driven shafts 33. Thus, each of the adjustable boards 20 is rotated to be in a manner that the absorption layer 22 of the adjustable board 20 is positioned outwards (i.e., towards the test chamber 101).

As detailed above, the length of each of the adjustable boards 20 equals the length of the opening 122 and a sum of widths of all of the adjustable boards 20 equals a width of the opening 122. Therefore, when the absorption layers 22 of all of the adjustable boards 20 are positioned outwards, each of the absorption layers 22 is in contact with two adjacent other absorption layer 22, or one adjacent other absorption layer 22 and the support board 12, and thus all of the absorption layers 22 cooperatively form an electromagnetic wave absorption surface 23 which entirely closes the opening 122. In this way, all inner surfaces of the test chamber 19 can absorb electromagnetic wave, and the test chamber 101 can serve as a fully anechoic chamber. Thus, tested ITE are positioned on the test position area 15 and turned on, and the test antenna 40 receives electromagnetic radiation signals generated by the ITE and transmits the electromagnetic radiation signals to the electromagnetic radiation strength measuring devices. In this way, the electromagnetic radiation strength measuring devices can perform quality testing that requires to be performed in fully anechoic chambers.

When the electromagnetic anechoic chamber 100 needs to serve as a semi anechoic chamber, the adjustable boards 20 are rotated by the drive unit 30 again, such that the reflection layer 21 of each of the adjustable board 20 is positioned outwards (i.e., towards the test chamber 101). Similar to the absorption layers 22, each of the reflection layers 21 is in contact with adjacent two adjacent other reflection layers 21, or one adjacent other reflection layer 21 and the support board 12, and thus all of the reflection layers 21 cooperatively form an electromagnetic wave reflection surface 25 which entirely closes the opening 122. In this way, one part of the inner surface of the test chamber 101 (i.e., the electromagnetic wave reflection surface 25) can reflect electromagnetic wave and all other parts of the inner surface of the test chamber 101 (i.e., the inner surface of the cover 19 and the top surface of the support board 12) can absorb electromagnetic wave. Thus, the test chamber 101 can serve as a semi anechoic chamber. Tested ITE are positioned on the test position area 15 and turned on, and the test antenna 40 receives electromagnetic radiation signals generated by the ITE and transmits the electromagnetic radiation signals to the electromagnetic radiation strength measuring devices. In this way, the electromagnetic radiation strength measuring devices can perform quality testing that requires to be performed in semi anechoic chambers.

Additionally, the adjustable boards 20 can also be manually rotated, if there are position inaccuracies of the adjustable boards 20 generated in rotating the adjustable boards 20 using the motor 31 they can be manually corrected.

In the present disclosure, rotating the adjustable boards 20 can enable the electromagnetic anechoic chamber 100 to be used as a fully anechoic chamber and a semi anechoic chamber, respectively. ITE which need to be respectively test in fully anechoic chambers and semi anechoic chambers can be always tested in the electromagnetic anechoic chamber 100, and thus transferring of the ITE between typical fully anechoic chambers and semi anechoic chambers can be omitted.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An electromagnetic anechoic chamber, comprising:
a support board defining an opening, electromagnetic wave absorptive material spread on the support board;
a cover covering the support board to form a test chamber between the cover and the support board, electromagnetic wave absorptive material spread on an inner surface of the cover; and
a plurality of adjustable boards received in the opening, each of the adjustable boards including an electromagnetic wave absorption layer disposed on one surface thereof and an electromagnetic wave reflection layer disposed on an opposite surface thereof, the adjustable boards rotatably mounted on the support board to selectively allow the electromagnetic wave absorption layer or the electromagnetic wave reflection layer being inward the test chamber.

2. The electromagnetic anechoic chamber as claimed in claim 1, wherein a length of each of the adjustable boards equals a length of the opening, and a sum of widths of all of the adjustable boards equal a width of the opening.

3. The electromagnetic anechoic chamber as claimed in claim 1, further comprising a drive unit configured for driving the adjustable boards to rotate.

4. The electromagnetic anechoic chamber as claimed in claim 3, wherein the drive unit includes a motor, a drive shaft, and a plurality of driven shafts corresponding to the adjustable boards; the drive shaft mounted on the motor and driven to rotate by the motor, each of the driven shafts fixed on a corresponding one of the adjustable boards, and rotation of the drive shaft driving the driven shafts and the adjustable boards to rotate.

5. The electromagnetic anechoic chamber as claimed in claim 4, wherein the drive unit further includes a plurality of transmission belts corresponding to the driven shafts and a plurality of pulleys coaxially mounted on the drive shaft, each of the transmission belts having one end coiled on a corresponding one of the pulleys and another end coiled on a corresponding one of the driven shafts for transmitting the rotation of the drive shaft to the driven shafts.

6. The electromagnetic anechoic chamber as claimed in claim 1, further comprising a test antenna received in the test chamber for receiving electromagnetic radiation signals from information technology equipments (ITE) received in the test chamber.

7. An electromagnetic anechoic chamber, comprising:
a support board defining an opening;
a cover covering the support board to form a test chamber between the cover and the support board; and
a plurality of adjustable boards rotatably mounted on the support board and received in the opening; wherein the test chamber serves as a fully anechoic chamber when each of the adjustable boards is rotated to a first position and serves as a semi anechoic chamber when each of the adjustable boards is rotated to a second position.

8. The electromagnetic anechoic chamber as claimed in claim 7, wherein each of the adjustable boards includes an absorption layer disposed on one surface thereof and a reflection layer disposed on an opposite surface thereof, the absorption layer configured for absorbing electromagnetic wave and the reflection layer configured for reflecting electromagnetic wave.

9. The electromagnetic anechoic chamber as claimed in claim 8, wherein electromagnetic wave absorptive material is spread on the support board and an inner surface of the cover, and the test chamber serves as a fully anechoic chamber when the absorption layer of each of the adjustable boards is positioned towards the test chamber and serves as a semi anechoic chamber when the reflection layer of each of the adjustable boards is positioned towards the test chamber.

10. The electromagnetic anechoic chamber as claimed in claim 7, wherein a length of each of the adjustable boards equals a length of the opening, and a sum of widths of all of the adjustable boards equal a width of the opening.

11. The electromagnetic anechoic chamber as claimed in claim 7, further comprising a drive unit configured for driving the adjustable boards to rotate.

12. The electromagnetic anechoic chamber as claimed in claim 11, wherein the drive unit includes a motor, a drive shaft, and a plurality of driven shafts corresponding to the adjustable boards; the drive shaft mounted on the motor and driven to rotate by the motor, each of the driven shafts fixed on a corresponding one of the adjustable boards, and rotation of the drive shaft driving the driven shafts and the adjustable boards to rotate.

13. The electromagnetic anechoic chamber as claimed in claim 12, wherein the drive unit further includes a plurality of transmission belts corresponding to the driven shafts and a plurality of pulleys coaxially mounted on the drive shaft, each of the transmission belts having one end coiled on a corresponding one of the pulleys and another end coiled on a corresponding one of the driven shafts for transmitting the rotation of the drive shaft to the driven shafts.

14. The electromagnetic anechoic chamber as claimed in claim 7, further comprising a test antenna received in the test chamber for receiving electromagnetic radiation signals from information technology equipments (ITE) received in the test chamber.
